(19) United States
(12) Patent Application Publication
(10) Pub. No.: US 2025/0181410 A1
(43) Pub. Date: Jun. 5, 2025

(54) SYSTEM AND METHOD TO IMPROVE SCHEDULING OF WORKLOAD BY IDENTIFYING FAULTS IN SYSTEMS

(71) Applicant: International Business Machines Corporation, Armonk, NY (US)

(72) Inventors: Abhishek Malvankar, White Plains, NY (US); Claudia Misale, White Plains, NY (US); Pedro David Bello-Maldonado, New York, NY (US); Seetharami R. Seelam, Chappaqua, NY (US); Marquita May Ellis, White Plains, NY (US); Alaa S. Youssef, Valhalla, NY (US)

(21) Appl. No.: 18/524,329

(22) Filed: Nov. 30, 2023

(51) Int. Cl. G06F 9/50

(52) U.S. Cl. CPC G06F 9/505

(57) ABSTRACT

A method, system, and a computer program product for improving scheduling of workload by identifying faults in systems is disclosed. The present invention may include receiving a configuration file associated with a configuration of the set of systems used for execution of a workload. The present invention may include retrieving event data associated with a set of events. The present invention may include determining a first set of parameters from first event data associated with a first event of the set of events. The present invention may include assigning an output label to a first workload termination parameter based on the first set of parameters and a presence of first configuration data within the received configuration file. The present invention may include storing the assigned output label to the first workload termination parameter in memory.

### BACKGROUND

The present disclosure relates to fault detection and, more particularly, to a workload management system and a method to improve the scheduling of workload by identifying faults in systems.

With advancements in hardware and software technologies enabling complex simulations, big data analytics, and scientific discoveries in recent years, high-performance computing (HPC) systems have evolved significantly. These HPC systems include numerous systems, each working collectively and contributing to the overall performance of the HPC cluster. Data-intensive user workloads (such as HPC workload and artificial intelligence (AI) workload) are executed on such HPC clusters for quicker execution. These HPC and AI workloads may need a group of processes to make progress in computation. Such group of processes may be spread across a single host or multiple regions in a cloud-native landscape.

During the execution of the HPC or AI workloads, failures (or faults) are inevitable in machines and associated systems especially when such workloads are executed for hours, days, or even weeks. There is a need to understand the events provided by the production workload to determine the hardware resource state. Hence, it may be advantageous to provide a way to detect failures in the systems and further schedule the workload on other systems for execution.

### SUMMARY

According to an embodiment of the present disclosure, a computer-implemented method for improving scheduling of workload by identifying faults in systems is described. The computer-implemented method includes receiving, by a computer, a configuration file associated with a set of systems. The configuration file includes information associated with a configuration of the set of systems used for an execution of a workload. The computer-implemented method further includes retrieving, by the computer, event data associated with a set of events occurring during the execution of the workload using the set of systems. The computer-implemented method further includes determining, by the computer, a first set of parameters from first event data associated with a first event of the set of events. The first set of parameters may be associated with a first system of the set of systems and may include information associated with a current status of the first system. The computer-implemented method further includes assigning an output label to a first workload termination parameter based on the determined first set of parameters and a presence of first configuration data associated with the first system within the received configuration file. The computer-implemented method further includes storing, by the computer, the assigned output label to the first workload termination parameter in memory.

According to one or more embodiments of the present disclosure, a system for identifying faults in systems is described. The system performs a method for improving scheduling of workload by identifying faults in systems. The method includes receiving a configuration file associated with a set of systems. The configuration file includes information associated with a configuration of the set of systems used for an execution of a workload. The method further includes retrieving event data associated with a set of events occurring during the execution of the workload using the set of systems. The method further includes determining a first set of parameters from first event data associated with a first event of the set of events. The first set of parameters may be associated with a first system of the set of systems and may include information associated with a current status of the first system. The method further includes assigning an output label to a first workload termination parameter based on the determined first set of parameters and a presence of first configuration data associated with the first system within the received configuration file. The method further includes storing the assigned output label to the first workload termination parameter in memory.

According to one or more embodiments of the present disclosure, a computer program product for improving scheduling of workload by identifying faults in systems is described. The computer program product includes a computer-readable storage medium having program instructions embodied therewith, the program instructions executable by a system to cause the system to receive a configuration file associated with a set of systems. The configuration file includes information associated with a configuration of the set of systems used for an execution of a workload. The program instructions further include retrieving, by the system, event data associated with a set of events occurring during the execution of the workload using the set of systems. The program instructions further include determining, by the system, a first set of parameters from first event data associated with a first event of the set of events. The first set of parameters is associated with a first system of the set of systems and includes information associated with a current status of the first system. The program instructions further include assigning, by the system, an output label to a first workload termination parameter based on the determined first set of parameters and a presence of first configuration data associated with the first system within the received configuration file. The program instructions further include storing, by the system, the assigned output label to the first workload termination parameter in memory.

Additional technical features and benefits are realized through the techniques of the present disclosure. Embodiments and aspects of the disclosure are described in detail herein and are considered a part of the claimed subject matter. For a better understanding, refer to the detailed description and to the drawings.

### BRIEF DESCRIPTION OF THE DRAWINGS

The following description will provide details of preferred embodiments with reference to the following figures, wherein:

FIG. 1 is a diagram that illustrates a computing environment for improving scheduling of workload by identifying faults in systems, in accordance with an embodiment of the disclosure;

FIG. 2 is a diagram that illustrates an environment for improving scheduling of workload by identifying faults in systems, in accordance with an embodiment of the disclosure;

FIG. 3 is a diagram that illustrates exemplary operations for improving scheduling of workload by identifying faults in systems, in accordance with an embodiment of the disclosure;

FIG. 4 is a diagram that illustrates an exemplary event data associated with a set of events occurring during the execution of the workload using the set of systems, in accordance with an embodiment of the disclosure;

FIG. 5 is a diagram that illustrates an exemplary training dataset for training of the ML model, in accordance with an embodiment of the disclosure;

FIG. 6 is a flowchart that illustrates an exemplary method for an assignment of the output label to a workload termination parameter based on a count of concurrent occurrences of first content in the first event data, in accordance with an embodiment of the disclosure;

FIG. 7 is a flowchart that illustrates an exemplary method for an assignment of the output label to a workload termination parameter based on a time period of concurrent occurrences of first content in the first event data, in accordance with an embodiment of the disclosure;

FIG. 8 is a diagram that illustrates an exemplary use case scenario for improving scheduling of workload by identifying faults in systems, in accordance with an embodiment of the disclosure; and

FIG. 9 is a flowchart that illustrates an exemplary method for improving scheduling of workload by identifying faults in systems, in accordance with an embodiment of the disclosure.

### DETAILED DESCRIPTION

Various aspects of the present disclosure are described by narrative text, flowcharts, block diagrams of systems, and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart operations may be performed in reverse order, as a single integrated operation, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

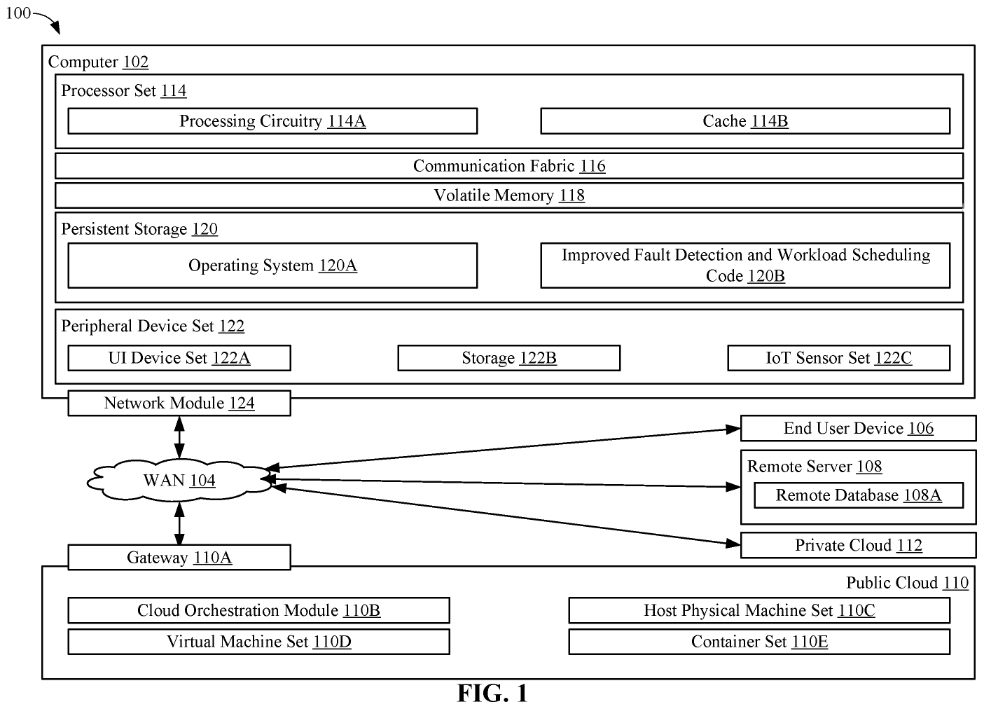

FIG. 1 is a diagram that illustrates a computing environment for improving scheduling of workload by identifying faults in systems, in accordance with an embodiment of the disclosure. With reference to FIG. 1, there is shown a computing environment 100 that contains an example of an environment for the execution of at least some of the computer code involved in performing the inventive methods, such as an improved fault detection and workload scheduling code 120B. In addition to the improved fault detection and workload scheduling code 120B, computing environment 100 includes, for example, a computer 102, a wide area network (WAN) 104, an end-user device (EUD) 106, a remote server 108, a public cloud 110, and a private cloud 112. In this embodiment, the computer 102 includes a processor set 114 (including a processing circuitry 114A and a cache 114B), a communication fabric 116, a volatile memory 118, a persistent storage 120 (including an operating system 120A and the improved fault detection and workload scheduling code 120B, as identified above), a peripheral device set 122 (including a user interface (UI) device set 122A, a storage 122B, and an Internet of Things (IoT) sensor set 122C), and a network module 124. The remote server 108 includes a remote database 108A. The public cloud 110 includes a gateway 110A, a cloud orchestration module 110B, a host physical machine set 110C, a virtual machine set 110D, and a container set 110E.

The computer 102 may take the form of a desktop computer, a laptop computer, a tablet computer, a smartphone, a smartwatch or other wearable computer, a mainframe computer, a quantum computer, or any other form of a computer or a mobile device now known or to be developed in the future that is capable of running a program, accessing a network or querying a database, such as a remote database 130. As is well understood in the art of computer technology, and depending upon the technology, the performance of a computer-implemented method may be distributed among multiple computers and/or between multiple locations. On the other hand, in this presentation of the computing environment 100, detailed discussion is focused on a single computer, specifically the computer 102, to keep the presentation as simple as possible. The computer 102 may be located in a cloud, even though it is not shown in a cloud in FIG. 1. On the other hand, computer 102 is not required to be in a cloud except to any extent as may be affirmatively indicated.

The processor set 114 includes one, or more, computer processors of any type now known or to be developed in the future. The processing circuitry 114A may be distributed over multiple packages, for example, multiple, coordinated integrated circuit chips. The processing circuitry 114A may implement multiple processor threads and/or multiple processor cores. The cache 114B may be memory that is located in the processor chip package(s) and is typically used for data or code that should be available for rapid access by the threads or cores running on the processor set 114. Cache memories are typically organized into multiple levels depending upon relative proximity to the processing circuitry 114A. Alternatively, some, or all, of the cache 114B for the processor set 114 may be located “off-chip.” In some computing environments, the processor set 114 may be designed for working with qubits and performing quantum computing.

Computer readable program instructions are typically loaded onto the computer 102 to cause a series of operations to be performed by the processor set 114 of the computer 102 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as the cache 114B and the other storage media discussed below. The program instructions, and associated data, are accessed by the processor set 114 to control and direct the performance of the inventive methods. In computing environment 100, at least some of the instructions for performing the inventive methods may be stored in the improved fault detection and workload scheduling code 120B in persistent storage 120.

The communication fabric 116 is the signal conduction path that allows the various components of computer 102 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

The volatile memory 118 is any type of volatile memory now known or to be developed in the future. Examples include dynamic type random access memory (RAM) or static type RAM. Typically, the volatile memory 118 is characterized by a random access, but this is not required unless affirmatively indicated. In the computer 102, the volatile memory 118 is located in a single package and is internal to computer 102, but alternatively or additionally, the volatile memory 118 may be distributed over multiple packages and/or located externally with respect to computer 102.

The persistent storage 120 is any form of non-volatile storage for computers that is now known or to be developed in the future. The non-volatility of this storage means that the stored data is maintained regardless of whether power is being supplied to computer 102 and/or directly to the persistent storage 120. The persistent storage 120 may be a read-only memory (ROM), but typically at least a portion of the persistent storage 120 allows writing of data, deletion of data, and re-writing of data. Some familiar forms of the persistent storage 120 include magnetic disks and solid-state storage devices. The operating system 120A may take several forms, such as various known proprietary operating systems or open-source Portable Operating System Interface-type operating systems that employ a kernel. The code included in the improved fault detection and workload scheduling code 120B typically includes at least some of the computer code involved in performing the inventive methods.

The peripheral device set 122 includes the set of peripheral devices of computer 102. Data communication connections between the peripheral devices and the other components of computer 102 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, the UI device set 122A may include components such as a display screen, speaker, microphone, wearable devices (such as goggles and smartwatches), keyboard, mouse, printer, touchpad, game controllers, and haptic devices. The storage 122B is external storage, such as an external hard drive, or insertable storage, such as an SD card. The storage 122B may be persistent and/or volatile. In some embodiments, storage 122B may take the form of a quantum computing storage device for storing data in the form of qubits. In embodiments where computer 102 is required to have a large amount of storage (for example, where computer 102 locally stores and manages a large database) then this storage may be provided by peripheral storage devices designed for storing very large amounts of data, such as a storage area network (SAN) that is shared by multiple, geographically distributed computers. The IoT sensor set 122C is made up of sensors that can be used in Internet of Things applications. For example, one sensor may be a thermometer and another sensor may be a motion detector.

The network module 124 is the collection of computer software, hardware, and firmware that allows computer 102 to communicate with other computers through WAN 104. The network module 124 may include hardware, such as modems or Wi-Fi signal transceivers, software for packetizing and/or de-packetizing data for communication network transmission, and/or web browser software for communicating data over the internet. In some embodiments, network control functions, and network forwarding functions of the network module 124 are performed on the same physical hardware device. In other embodiments (for example, embodiments that utilize software-defined networking (SDN)), the control functions and the forwarding functions of the network module 124 are performed on physically separate devices, such that the control functions manage several different network hardware devices. Computer-readable program instructions for performing the inventive methods can typically be downloaded to computer 102 from an external computer or external storage device through a network adapter card or network interface included in the network module 124.

The WAN 104 is any wide area network (for example, the internet) capable of communicating computer data over non-local distances by any technology for communicating computer data, now known or to be developed in the future. In some embodiments, the WAN 104 may be replaced and/or supplemented by local area networks (LANs) designed to communicate data between devices located in a local area, such as a Wi-Fi network. The WAN 104 and/or LANs typically include computer hardware such as copper transmission cables, optical transmission fibers, wireless transmission, routers, firewalls, switches, gateway computers, and edge servers.

The EUD 106 is any system that is used and controlled by an end user (for example, a customer of an enterprise that operates computer 102) and may take any of the forms discussed above in connection with computer 102. The EUD 106 typically receives helpful and useful data from the operations of computer 102. For example, in a hypothetical case where computer 102 is designed to provide a recommendation to an end user, this recommendation would typically be communicated from the network module 124 of computer 102 through WAN 104 to EUD 106. In this way, the EUD 106 can display, or otherwise present, the recommendation to an end user. In some embodiments, EUD 106 may be a client device, such as a thin client, heavy client, mainframe computer, desktop computer, and so on.

The remote server 108 is any system that serves at least some data and/or functionality to the computer 102. The remote server 108 may be controlled and used by the same entity that operates the computer 102. The remote server 108 represents the machine(s) that collect and store helpful and useful data for use by other computers, such as the computer 102. For example, in a hypothetical case where the computer 102 is designed and programmed to provide a recommendation based on historical data, then this historical data may be provided to the computer 102 from the remote database 130 of the remote server 108.

The public cloud 110 is any system available for use by multiple entities that provides on-demand availability of system resources and/or other computer capabilities, especially data storage (cloud storage) and computing power, without direct active management by the user. Cloud computing typically leverages the sharing of resources to achieve coherence and economies of scale. The direct and active management of the computing resources of the public cloud 110 is performed by the computer hardware and/or software of the cloud orchestration module 110B. The computing resources provided by the public cloud 110 are typically implemented by virtual computing environments that run on various computers making up the computers of the host physical machine set 110C, which is the universe of physical computers in and/or available to the public cloud 110. The virtual computing environments (VCEs) typically take the form of virtual machines from the virtual machine set 110D and/or containers from the container set 110E. It is understood that these VCEs may be stored as images and may be transferred among and between the various physical machine hosts, either as images or after the instantiation of the VCE. The cloud orchestration module 110B manages the transfer and storage of images, deploys new instantiations of VCEs, and manages active instantiations of VCE deployments. The gateway 110A is the collection of computer software, hardware, and firmware that allows public cloud 110 to communicate through WAN 104.

The VCEs can be stored as “images”. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

The private cloud 112 is similar to public cloud 110, except that the computing resources are only available for use by a single enterprise. While the private cloud 112 is depicted as being in communication with the WAN 104, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, the public cloud 110 and the private cloud 112 are both part of a larger hybrid cloud.

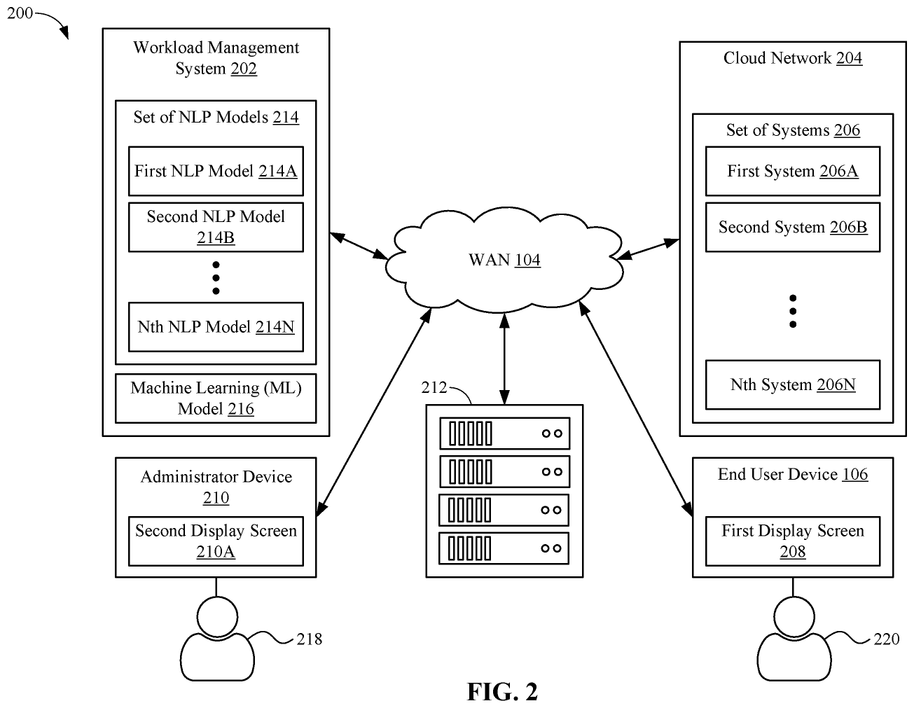

FIG. 2 is a diagram that illustrates an environment for improving scheduling of workload by identifying faults in systems, in accordance with an embodiment of the disclosure. FIG. 2 is explained in conjunction with elements from FIG. 1. With reference to FIG. 2, there is shown a diagram of a network environment 200. The network environment 200 includes a workload management system 202, a cloud network 204, a set of systems 206, a first display screen 208, an administrator device 210, a second display screen 210A, and a server 212. In an embodiment, the workload management system 202 may include a set of natural language processing (NLP) models 214 and a machine learning (ML) model 216. The network environment 200 may further include the EUD 106, and the WAN 104 of FIG. 1. With reference to FIG. 2, there is further shown an administrator 218 associated with the administrator device 210, and a user 220 associated with the EUD 106. The set of systems 206 may be hosted on the cloud network 204 (such as the public cloud 110 or the private cloud 112 of FIG. 1). In an embodiment, the workload management system 202 may be an exemplary embodiment of the computer 102 of FIG. 1.

The workload management system 202 may include suitable logic, circuitry, interfaces, and/or code that may be configured to improve scheduling of workload by identifying faults in systems. The workload management system 202 may be configured to receive a configuration file associated with a configuration of a set of systems. The workload management system 202 may be further configured to retrieve event data associated with a set of events occurring during an execution of a workload based on the received configuration file. The workload may be executed using the set of systems. The workload management system 202 may be further configured to determine a first set of parameters associated with a first event of the set of events. The first set of parameters may be associated with a first system 206A of the set of systems 206 and may include information associated with a current status of the first system 206A. The workload management system 202 may be further configured to assign an output label to a first workload termination parameter based on the determined first set of parameters and the received configuration file. The workload management system 202 may be further configured to store the assigned output label to the first workload termination parameter in memory. Examples of the workload management system 202 may include, but are not limited to, a computing device, a virtual computing device, a mainframe machine, a server, a computer workstation, a smartphone, a cellular phone, a mobile phone, a gaming device, and a consumer electronic (CE) device.

The cloud network 204 may refer to a distributed computing infrastructure that may allow users (such as the user 220) to access and share resources, services, and information over the internet. In the cloud network 204, computing resources such as servers, storage, and applications are hosted and managed by third-party providers in data centers. The users may access these resources on-demand, typically paying for usage on a subscription or pay-as-you-go basis. The cloud networks may enable scalability, flexibility, and cost-effectiveness, as users may easily scale their computing resources up or down based on their needs without the burden of maintaining physical hardware and infrastructure. The cloud network 204 may correspond to one of the public cloud 110 or the private cloud 112. Details about the public cloud 110 or the private cloud 112 are provided, for example, in FIG. 1.

Each system of the set of systems 206 may include suitable logic, circuitry, interfaces, and/or code that may be configured to execute the workload. Each system of the set of systems 206 may correspond to a component or a specialized unit within the cloud network 204 (such as the public cloud 110 or the private cloud 112) that work together to achieve specific functionalities desired for the execution of the workload. In an embodiment, each system of the set of systems 206 may be considered as a distinct module or component with specific roles and responsibilities within a larger cloud architecture. Different types of the set of systems 206 may include, but are not limited to, a system, a storage system, a networking system, a security system, a database system, and a monitoring and management system. Examples of the set of systems 206 may include, but are not limited to, a processor system, a graphics processor system, a file system, and memory system. As shown in FIG. 2, the set of systems 206 may include a first system 206A, a second system 206B, up to an Nth system 206N.

The EUD 106 may include suitable logic, circuitry, interfaces, and/or code that may provide the configuration file and the workload, as a user input, to the workload management system 202. In another embodiment, the EUD 106 may be configured to output the one or more reasons on the first display screen 208. The EUD 106 may be associated with the user 220 who might wish to execute the workload on the cloud network 204 using the set of systems 206. Examples of the EUD 106 may include, but are not limited to, a computing device, a mainframe machine, a server, a computer workstation, a smartphone, a cellular phone, a mobile phone, a gaming device, and a consumer electronic (CE) device.

The first display screen 208 may comprise suitable logic, circuitry, and interfaces that may be configured to display a failure message indicating a termination of the execution of the workload on the set of systems 206 due to a presence of at least one fault in at least one of the set of systems 206. In another embodiment, the first display screen 208 may further display one or more user interface (UI) elements from which the user 220 may be able to provide the user inputs. In some embodiments, the first display screen 208 may be an external display device associated with the EUD 106. The first display screen 208 may be a touch screen which may enable the user to provide the user input via the first display screen 208. The touch screen may be at least one of a resistive touch screen, a capacitive touch screen, or a thermal touch screen. The first display screen 208 may be realized through several known technologies such as, but are not limited to, at least one of a Liquid Crystal Display (LCD) display, a Light Emitting Diode (LED) display, a plasma display, or an Organic LED (OLED) display technology, or other display devices. In accordance with an embodiment, the first display screen 208 may refer to a display screen of a head-mounted device (HMD), a smart-glass device, a see-through display, a projection-based display, an electro-chromic display, or a transparent display.

The administrator device 210 may include suitable logic, circuitry, interfaces, and/or code that may provide inputs to the set of systems 206 or the workload management system 202. In another embodiment, the administrator device 210 may be configured to output the one or more reasons. Specifically, the workload management system 202 may control the second display screen 210A of the administrator device 210 to display the one or more reasons. The administrator device 210 may be associated with the administrator 218 who might be responsible for the management of cloud network 204 or the set of systems 206. Examples of the administrator device 210 may include, but are not limited to, a computing device, a mainframe machine, a server, a computer workstation, a smartphone, a cellular phone, a mobile phone, a gaming device, or a consumer electronic (CE) device.

The second display screen 210A may comprise suitable logic, circuitry, and interfaces that may be configured to display the one or more reasons. In another embodiment, the second display screen 210A may further display one or more user interface (UI) elements from which the administrator 218 may be able to provide one or more inputs. In some embodiments, the second display screen 210A may be an external display device associated with the administrator device 210. The second display screen 210A may be a touch screen which may enable the administrator 218 to provide the user input via the second display screen 210A. The touch screen may be at least one of a resistive touch screen, a capacitive touch screen, or a thermal touch screen. The first display screen 210A may be realized through several known technologies such as, but not limited to, at least one of a Liquid Crystal Display (LCD) display, a Light Emitting Diode (LED) display, a plasma display, or an Organic LED (OLED) display technology, or other display devices. In accordance with an embodiment, the first display screen 208 may refer to a display screen of a head-mounted device (HMD), a smart-glass device, a see-through display, a projection-based display, an electro-chromic display, or a transparent display.

The server 212 may include suitable logic, circuitry, and interfaces, and/or code that may be configured to store the configuration file, the workload, and the determined first set of parameters. The server 212 may be further configured to store the output label, the set of NLP models 214, the failure message, and the determined one or more reasons. The server 212 may be implemented as a cloud server and may execute operations through web applications, cloud applications, HTTP requests, repository operations, file transfer, and the like. Other example implementations of the server 212 may include, but are not limited to, a database server, a file server, a web server, a media server, an application server, a mainframe server, or a cloud computing server.

In at least one embodiment, the server 212 may be implemented as a plurality of distributed cloud-based resources by use of several technologies that are well known to those ordinarily skilled in the art. A person with ordinary skill in the art will understand that the scope of the disclosure may not be limited to the implementation of the server 212 and the workload management system 202 as two separate entities. In certain embodiments, the functionalities of the server 212 can be incorporated in its entirety or at least partially in the workload management system 202 or vice-versa, without a departure from the scope of the disclosure.

Each NLP model of the set of NLP models 214 may be computational models that may be designed to understand, interpret, and generate human language. Each NLP model of the set of NLP models 214 models leverage techniques from machine learning and artificial intelligence to perform tasks such as entity detection, language translation, sentiment analysis, and text summarization. Different types of NLP models 214 may include, but not limited to, a rule-based model and statistical model. Specifically, the rule-based model may involve creating a set of rules and patterns to identify and process language patterns. Example of a rule-based model may be part-of-speech tagging, which identifies the grammatical parts of a sentence, such as nouns, verbs, and adjectives.

The statistical model may use statistical techniques to learn patterns and structures within language data. Example of a statistical language processing model may be the use of a recurrent neural networks (RNNs) for language generation and sequence prediction tasks. For instance, RNNs can be used to generate text in the style of a particular author or to complete sentences in predictive typing applications. These models are continuously improved and refined through the use of large datasets and ongoing research in the field of natural language processing.

In an embodiment, the set of NLP models 214 may include her first NLP model 214A, a second NLP model 214B, and Nth NLP model 214N. Each NLP model of the set of NLP models may be associated with each system of the set of systems 206. Specifically, each NLP model of the set of NLP models 214 may be trained and customized for event data associated with a particular system of the set of systems 206. For example, the first NLP model 214A may be associated with the first system 206A, the second NLP model 214B may be associated with the second system 206B, and the Nth NLP model 214N may be associated with the Nth system 206N.

The ML model 216 may correspond to a neural network model that may be a computational network or a system of artificial neurons, arranged in a plurality of layers, as nodes. The plurality of layers of the neural network may include an input layer, one or more hidden layers, and an output layer. Each layer of the plurality of layers may include one or more nodes (or artificial neurons). Outputs of all nodes in the input layer may be coupled to at least one node of hidden layer(s). Similarly, inputs of each hidden layer may be coupled to outputs of at least one node in other layers of the neural network. Outputs of each hidden layer may be coupled to inputs of at least one node in other layers of the neural network. Node(s) in the final layer may receive inputs from at least one hidden layer to output a result. The number of layers and the number of nodes in each layer may be determined from hyper-parameters of the neural network. Such hyper-parameters may be set before or while training the neural network on a training dataset.

Each node of the neural network may correspond to a mathematical function (e.g., a sigmoid function or a rectified linear unit) with a set of parameters, tunable during training of the network. The set of parameters may include, for example, a weight parameter, a regularization parameter, and the like. Each node may use the mathematical function to compute an output based on one or more inputs from nodes in other layer(s) (e.g., previous layer(s)) of the neural network. All or some of the nodes of the neural network may correspond to the same or a different mathematical function.

In training of the neural network, one or more parameters of each node of the neural network may be updated based on whether an output of the final layer for a given input (from the training dataset) matches a correct result based on a loss function for the neural network. The above process may be repeated for the same or a different input until a minima of loss function may be achieved, and a training error may be minimized. Several methods for training are known in art, for example, gradient descent, stochastic gradient descent, batch gradient descent, gradient boost, meta-heuristics, and the like.

The neural network may include electronic data, such as, for example, a software program, code of the software program, libraries, applications, scripts, or other logic or instructions for execution by a processing device, such as circuitry. The neural network may include code and routines configured to enable a computing device, such as the workload management system 202, to perform one or more operations. Additionally or alternatively, the neural network may be implemented using hardware including a processor, a microprocessor (e.g., to perform or control performance of one or more operations), a field-programmable gate array (FPGA), or an application-specific integrated circuit (ASIC). Alternatively, in some embodiments, the neural network may be implemented using a combination of hardware and software. Examples of the neural network may include, but are not limited to, a deep neural network (DNN), a convolutional neural network (CNN), a CNN-recurrent neural network (CNN-RNN), R-CNN, Fast R-CNN, Faster R-CNN, an artificial neural network (ANN), a fully connected neural network, and/or a combination of such networks.

Although in FIG. 2, the set of NLP models 214 and the ML model 216 are shown integrated within the workload management system 202, the disclosure is not so limited. Accordingly, in some embodiments, the set of NLP models 214 and the ML model 216 may be separate entities from the workload management system 202, without deviation from the scope of the disclosure. In an embodiment, the set of NLP models 214 and the ML model 216 may be stored in the server 212.

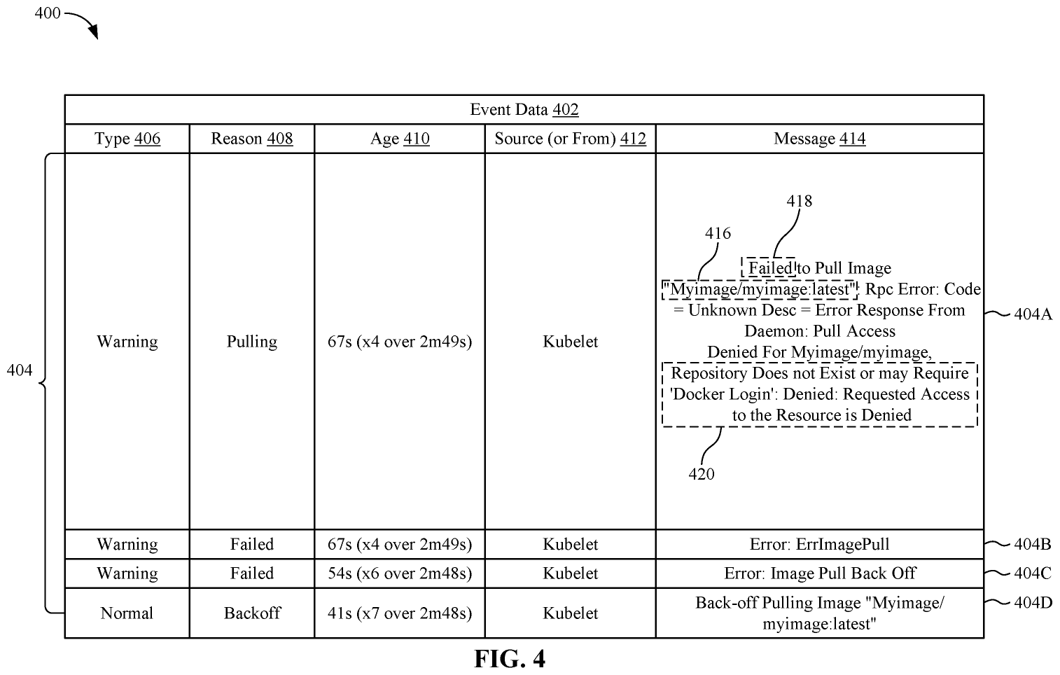

In operation, the user 220 may have to execute the workload on the set of systems 206 hosted on the cloud network 204 (such as the public cloud 110 or the private cloud 112). To execute the workload, the user 220 may upload a configuration associated with the set of systems 206. The workload management system 202 may receive the configuration file associated with the set of systems 206 from the EUD 106 associated with the user 220. The configuration file may include information associated with a configuration of the set of systems 206 that may be used for the execution of the workload. Specifically, the workload may be executed on the set of systems 206. The workload management system 202 may be configured to retrieve event data associated with a set of events occurring during the execution of the workload using the set of systems 206. Details about the set of events are provided, for example, in FIG. 4.

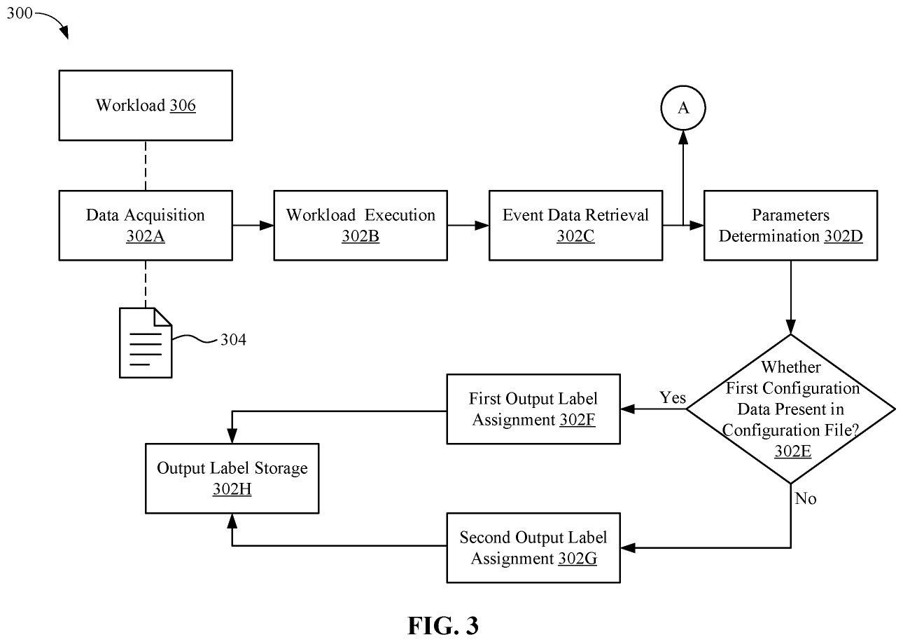

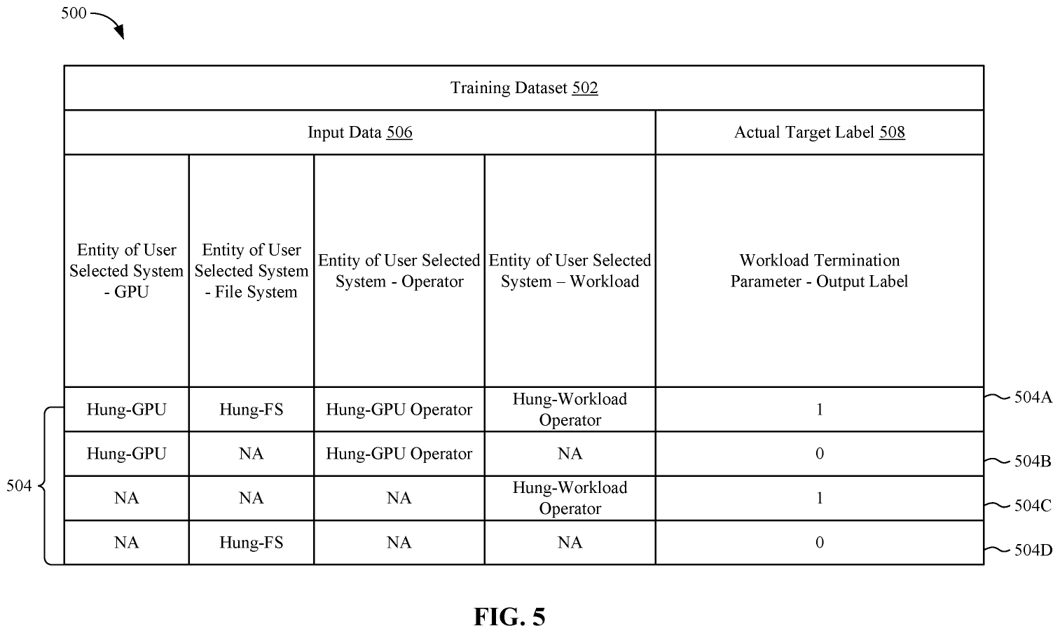

The workload management system 202 may be further configured to determine a first set of parameters from first event data associated with a first event of the set of events. The first set of parameters may be associated with a first system 206A of the set of systems 206 and may include information associated with a current status of the first system 206A. The workload management system 202 may be further configured to assign an output label to a first workload termination parameter based on the determined first set of parameters and a presence of first configuration data associated with the first system 206A within the received configuration file and store the assigned output label to the first workload termination parameter in the memory (such as the volatile memory 118 or the persistent storage 120). Details about the workload termination parameter are provided, for example, in FIG. 3 and FIG. 5.

FIG. 3 is a diagram that illustrates exemplary operations for improving scheduling of workload by identifying faults in systems, in accordance with an embodiment of the disclosure. FIG. 3 is explained in conjunction with elements from FIG. 1 and FIG. 2. With reference to FIG. 3, there is shown a block diagram 300 that illustrates exemplary operations from 302A to 302H, as described herein. The exemplary operations illustrated in the block diagram 300 may start at 302A and may be performed by any computing system, apparatus, or device, such as by the computer 102 (or the processing circuitry 114A) of FIG. 1 or the workload management system 202 of FIG. 2. Although illustrated with discrete blocks, the exemplary operations associated with one or more blocks of the block diagram 300 may be divided into additional blocks, combined into fewer blocks, or eliminated, depending on the particular implementation.

At 302A, a data acquisition operation may be performed. In the data acquisition operation, the workload management system 202 may be configured to receive a configuration file 304 associated with the set of systems 206. Specifically, the configuration file 304 associated with the set of systems 206 may correspond to a file that may include settings and parameters for multiple interconnected components or modules within a larger system (such as the cloud network 204). The configuration file 304 may allow users (such as the user 220) to define and customize the behavior of various systems independently, facilitating the management and configuration of the set of systems 206. Each system may typically have its section or namespace within the configuration file 304, where specific settings for that system may be defined.

In an embodiment, the configuration file 304 may be written in a mark-up language. Examples of the mark-up language may include, but are not limited to, a yet another markup language (YAML), a hypertext markup language (HTML), an extensible markup language (XML), a JavaScript object notation (JSON), a standard generalized markup language (SGML), and an extensible hypertext markup language (XHTML). Details about the mark-up language are known in the art and have been omitted for the sake of brevity.

An example of the configuration file 304 written in YAML may be provided below:

```
  apiVersion: apps/v1
  kind: Deployment
  metadata:
    name: nginx-deployment
  spec:
    selector:
      matchLabels:
        app: nginx
    minReadySeconds: 5
    template:
      metadata:
        labels:
          app: nginx
      spec:
        containers:
        - name: nginx
          image: nginx:1.14.2
          ports:
- containerPort: 80
```

In an embodiment, the workload management system 202 may receive the configuration file 304 from the user 220 via the EUD 106. In another embodiment, the configuration file 304 may be received from the administrator device 210 associated with the administrator 218 of the cloud network 204. In an alternate embodiment, the workload management system 202 may receive the configuration file 304 associated with the set of systems 206 from a cloud orchestrator (or the cloud orchestration module 110B) associated with the cloud network 204 on which the set of systems 206 may be hosted. Specifically, the cloud orchestrator may correspond to a software tool that may be used to automate and manage the deployment, scaling, and management of applications and services across the cloud network 204.

Based on the reception of the configuration file 304, the workload management system 202 may be further configured to receive a workload 306 to be executed using the set of systems 206. The workload 306 may be received from the user 220 via the EUD 106. The workload 306 may refer to a specific set of tasks, processes, or operations that may be executed to accomplish a particular goal or function. The workload 306 may be composed of interactions and collaborations among various systems, each responsible for specific functionalities within the set of systems 206. In an embodiment, the set of systems 206 may include, but is not limited to, a processor system, a graphics processor system, a file system, and memory system. In an embodiment, the workload management system 202 may receive the configuration file 304, and the workload 306 concurrently.

At 302B, a workload execution operation may be performed. In the workload execution operation, the workload management system 202 may be configured to execute the workload 306. In an embodiment, the received workload 306 may be executed on the set of systems 206. In some embodiments, the received workload 306 may be executed using the set of systems 206. For example, if the set of systems 206 corresponds to the processor system or the graphics processor system, then the received workload may be executed on the set of systems 206. As another example, if the set of systems 206 may correspond to the file system, then the received workload may be executed using the set of systems 206. In an embodiment, the workload management system 202 may be configured to transfer a command to the cloud orchestrator to execute the workload on the set of systems 206 hosted on the cloud network 204. Based on the reception of the command from the workload management system 202, the cloud orchestrator may be configured to start an execution of the workload 306 using the set of systems 206.

At 302C, an event data retrieval operation may be performed. In the event data retrieval operation, the workload management system 202 may be configured to retrieve event data associated with a set of events that may occur during the execution of the workload 306 using the set of systems 206. In an embodiment, the event data may include information associated with one or more events that may be happening during the execution of the workload 306 using the set of systems 206.

In an embodiment, the event data may refer to information generated by events or occurrences within the set of systems 206. In an embodiment, the event data may correspond to log data associated with this set of events that may occur during the execution of the workload 306. These events (or occurrences) may correspond to user interactions, system notifications, changes in state, or any significant incident that any system of the set of systems 206 may track or respond to. The event data may be valuable for monitoring, analysis, and understanding the behavior of the system or the status of the workload 306 over time. In an embodiment, the event data may include multiple fields such as, but not limited to, a type of event, a reason for the event, an age of the event, a source (from) of the event, and a message associated with the event. Details about the event data are provided, for example, in FIG. 4.

At 302D, a parameters determination operation may be performed. In the parameters determination operation, the workload management system 202 may be configured to determine a first set of parameters from the first event data associated with a first event of the set of events. In an embodiment, the first set of parameters is associated with the first system 206A of the set of systems 206 and may include information associated with a current status of the first system 206A of the set of systems 206. By way of example, the first set of parameters may include a name entity, a status entity, and a reason entity. Specifically, the workload management system 202 may be configured to extract values for each parameter of the first set of parameters for the first event of the set of events.

In an embodiment, the workload management system 202 may be configured to parse the first event data. After parsing the first event data, the workload management system 202 may be configured to apply the first NLP model 214A of the set of NLP models 214 on the parsed first event data. The first NLP model 214A may be a pre-trained model that may be trained to determine the values of the first set of parameters. Based on the application of the first NLP model 214A on the first event data, the workload management system 202 may be configured to determine the values of the first set of parameters.

In an alternate embodiment, the workload management system 202 may be configured to determine the first system 206A associated with the first event. Based on the determined first system 206A, the workload management system 202 may be configured to select at least one NLP model of the set of NLP models 214 to be applied to the first event data. For example, if the determined first system 206A corresponds to the processor system, the workload management system 202 may be configured to select the first NLP model 214A of the set of NLP models 214. As another example, if the determined first system 206A corresponds to the file system, the workload management system 202 may be configured to select the second NLP model 214B of the set of NLP models 214. This may be done because in one of the embodiments each NLP model of the set of NLP models 214 may be trained on the event data associated with only one system of the set of systems 206.

At 302E, it may be determined whether the first configuration data is present or absent in the configuration file 304. In an embodiment, the workload management system 202 may be configured to determine the presence of the first configuration data associated with the first system 206A within the received configuration file 304. Specifically, the first configuration data may correspond to the configuration of the first system 206A of the set of systems 206 hosted on the cloud network 204. This may be done because the disclosed workload management system 202 may detect faults if the configuration of the corresponding system is present in the configuration file 304 that may be specified by the user 220. In case the configuration is not specified by the user 220, the disclosed workload management system 202 may not detect the fault as it may not be due to the wrong configuration of the corresponding system from the user 220. If the first configuration data is present in the configuration file 304, the control may be passed to 302F. Otherwise, the control may be transferred to 302G.

At 302F, a first output label assignment operation may be executed. In the first output label assignment operation, the workload management system 202 may be configured to assign an output label to a first workload termination parameter. The first workload termination parameter may be associated with a termination of the execution of the workload on the first system 206A or on the set of systems 206. In an embodiment, the workload management system 202 may be configured to assign the output label to the first workload termination parameter based on the determined first set of parameters and the presence of first configuration data associated with the first system 206A within the received configuration file 304. Specifically, the assigned output label may be of a first value (e.g., ‘1’). In an embodiment, the assignment of the first value to the output label may correspond to a detection of at least one fault in the set of systems 206 specified (or selected) by the user 220.

In an embodiment, the workload management system 202 may be configured to provide the determined first set of parameters and the first configuration file, as an input, to the ML model 216. As discussed above, the ML model 216 may be a pre-trained model that may be trained on a training dataset to assign the output label of the first value to the first workload termination parameter. Based on the output of the ML model 216, the workload management system 202 may be configured to assign the output label of the first value to the workload termination parameter.

In case the output label of the first value is assigned to the workload termination parameter, the workload management system 202 may be configured to terminate the workload on the first system 206A or the set of systems 206. The workload management system 202 may be configured to determine one or more reasons associated with the assignment of the output label of the first value of ‘1’ to the first workload termination parameter based on an analysis of the first event data. Specifically, the workload management system 202 may be configured to apply an NLP model (e.g., the Nth NLP model 214N) of the set of NLP models 214 on the first event data to determine the one or more reasons in a human-readable natural language format for the assignment of the output label of the first value to the workload termination parameter. The determined one or more reasons may be further rendered on the first display screen 208 associated with the EUD 106. The one or more reasons may be used by the user to rectify one or more errors associated with the first system 206A.

In another embodiment, the workload management system 202 may be configured to schedule the terminated workload on the second system 206B of the set of systems 206. In an embodiment, the second system 206B may be similar to the first system 206A and may perform similar operations as that of the first system 206A.

At 302G, a second output label assignment operation may be executed. In the second output label assignment operation, the workload management system 202 may be configured to assign the output label to the first workload termination parameter. In an embodiment, the workload management system 202 may be configured to assign the output label to the first workload termination parameter based on the determined first set of parameters and the absence of the first configuration data associated with the first system 206A within the received configuration file 304. Specifically, the assigned output label may be of a second value (e.g., ‘0’). As discussed above, the first workload termination parameter may be associated with a termination of the execution of the workload on the first system 206A or the set of systems 206. In an embodiment, the assignment of the second value to the output label may correspond to a detection of no fault or the detection of at least one fault in the one or systems different from the set of systems 206. The one or more systems may be used by the cloud orchestrator to execute the workload 306 on the set of systems 206.

In an embodiment, the workload management system 202 may be configured to provide the determined first set of parameters and the configuration file 304, as the input, to the ML model 216. As discussed above, the ML model 216 may be the pre-trained model that may be trained on the training dataset for assigning the output label of the second value to the first workload termination parameter. Based on the output of the ML model 216, the workload management system 202 may be configured to assign the output label of the second value to the workload termination parameter. Details about the ML model 216 are provided, for example, in FIG. 5.

In case the output label of the second value is assigned to the workload termination parameter, the workload management system 202 may be configured to determine one or more reasons associated with the assignment of the output label of the second value of ‘0’ to the first workload termination parameter based on an analysis of the first event data. Specifically, the workload management system 202 may be configured to apply an NLP model of the set of NLP models 214 on the first event data to determine the one or more reasons in a human-readable natural language format for the assignment of the output label of the first value to the workload termination parameter. The determined one or more reasons may be further rendered on the second display screen associated with the administrator device 210 associated with the administrator 218 of the cloud network. The one or more reasons may be used by the administrator to rectify one or more errors if present.

In another embodiment, the workload management system 202 may be further configured to terminate the execution of the workload on the first system 206A based on an assignment of the output label of the first value to the first workload termination parameter. The workload management system 202 may be further configured to output a failure message indicating the termination of the execution of the workload 306 on the first system 206A due to the presence of at least one fault in the first system 206A.

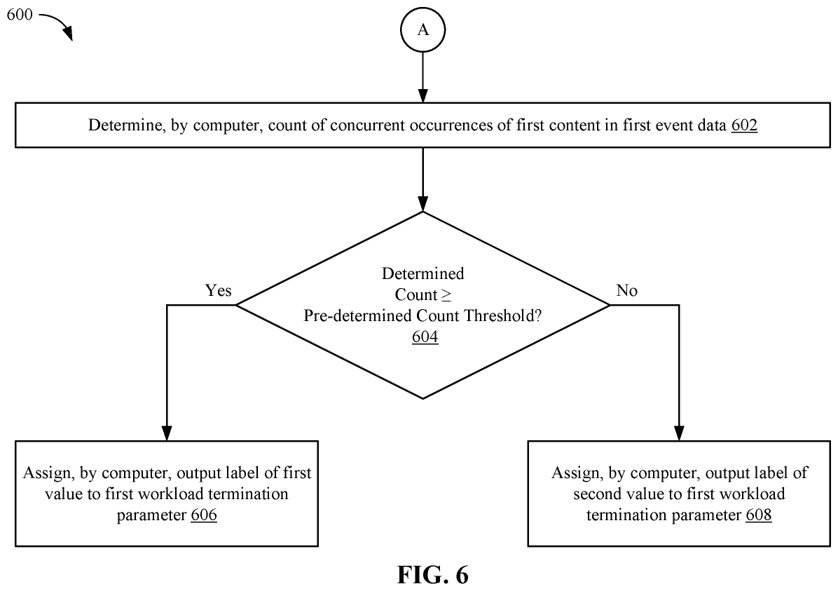

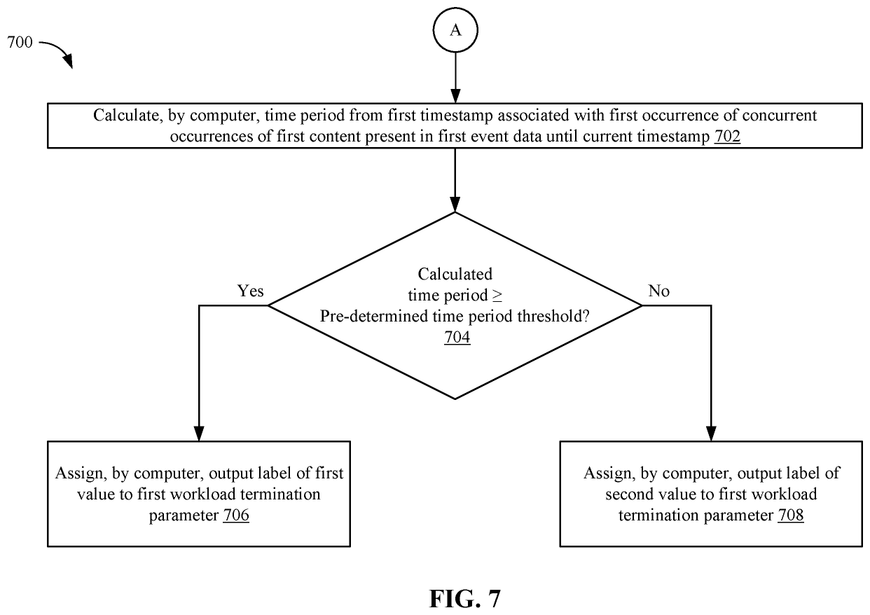

In an embodiment, the output label may be assigned based on a count of concurrent occurrences of first content in the first event data. In another embodiment, the output label may be assigned based on a time period from a first timestamp associated with a first occurrence of concurrent occurrences of first content present in the first event data until a current timestamp. Details about the assignment of the output label to the workload termination parameter based on the count of the concurrent occurrences of the first content in the first event data are provided, for example, in FIG. 6. Details about the assignment of the output label to the workload termination parameter based on the time period from the first timestamp associated with the first occurrence of concurrent occurrences of the first content present in the first event data until the current timestamp are provided, for example, in FIG. 7.

At 302H, an output label storage operation may be performed. In the output label storage operation, the workload management system 202 may be configured to store the assigned output label to the first workload termination parameter in the memory (such as the volatile memory 118 or the persistent storage 120). In another embodiment, the workload management system 202 may be configured to display the value of the assigned output label on the first display screen 208 or the second display screen 210A. The workload management system 202 may further display the determined one or more reasons on the first display screen 208 or the second display screen 210A.

FIG. 4 is a diagram that illustrates an exemplary event data associated with a set of events occurring during the execution of the workload using the set of systems, in accordance with an embodiment of the disclosure. FIG. 4 is explained in conjunction with elements from FIG. 1, FIG. 2, and FIG. 3. With reference to FIG. 4, there is shown a diagram 400 that includes event data 402.

The event data 402 may be associated with a set of events 404 that may occur during the execution of the workload using the set of systems. The event data 402 may include multiple fields such as, but not limited to, a type 406 field, a reason 408 field, an age 410 field, a source 412 field, and a message 414 field. Such multiple fields may be associated with each event of the set of events. For example, there are shown 5 events e.g., a first event 404A, a second event 404B, a third event 404C, and a fourth event 404D associated with a single system.

As another example, the type 406 of the first event 404A may be ‘warning’, the reason 408 of the first event 404A may be ‘failed, the age 410 of the first event 404A may be ‘67s (x4 over 2m49s)’, the source 412 of the second event 404B may be ‘kubelet’, and the message 414 of first event 404A may be ‘Failed to pull image “myimage/myimage: latest”: rpc error: code=Unknown desc=Error response from daemon: pull access denied for myimage/myimage, repository does not exist or may require ‘docker login’: denied: requested access to the resource is denied’.

In an embodiment, the workload management system 202 may apply the first NLP model 214A of the set of NLP models 214 on the message 414 associated with the corresponding event to determine the set of parameters (or the values for the set of parameters). In an embodiment, a first portion 416 of message 414 may be used to determine a name entity, the second portion 418 of the message 414 may be used to determine a status entity, and a third portion 420 of the message 414 may be used to determine a reason entity.

By way of example and not limitation, the name entity associated with the first event 404A may be ‘myimage/myimage: latest’. The status entity associated with the first event 404A may be ‘Failed’ and the reason entity associated with the first event 404A may be ‘repository does not exist or may require ‘docker login’: denied: requested access to the resource is denied’.

FIG. 5 is a diagram that illustrates an exemplary training dataset for training of the ML model, in accordance with an embodiment of the disclosure. FIG. 5 is explained in conjunction with elements from FIG. 1, FIG. 2, FIG. 3, and FIG. 4. With reference to FIG. 5, there is shown a diagram 500 that includes a training dataset 502.

The training dataset 502 may include a set of training samples 504 that may be used to train the ML model 216. The training dataset 502 may include input data 506 and corresponding actual target labels 508, providing the ML model 216 with the information it requires to learn and further make predictions. The training process may involve presenting the ML model 216 with input data 506 and adjusting its internal parameters iteratively to minimize the difference between its predicted outputs and the actual target labels 508 in the training dataset 502. This process may enable the ML model 216 to generalize and make accurate predictions on new, unseen data in real-world usage scenarios.

As shown in the FIG. 5, the set of training samples 504 may include a first training sample 504A, a second training sample 504B, a third training sample 504C, and a fourth training sample 504D. As per the first training sample 504A, the value of the parameter ‘Entity of user selected System-GPU’ may be ‘Hung-GPU’, the value of the parameter ‘Entity of user selected System-File system’ may be ‘Hung-FS’, the value of the parameter ‘Entity of user selected System-Operator’ may be ‘Hung-GPU Operator’, the value of the parameter ‘Entity of user selected System-Workload’ may be ‘Hung-workload Operator’, and the output label may be ‘1’.

As another example, in the fourth training sample 504D, the value of the parameter ‘Entity of user selected System-GPU’ may be ‘NA’, the value of the parameter ‘Entity of user selected System-File system’ may be ‘Hung-FS’, the value of the parameter ‘Entity of user selected System-Operator’ may be ‘NA, the value of the parameter ‘Entity of user selected System—Workload’ may be ‘NA’, and the output label may be ‘0’. This may be because ‘Hung-FS’ may not be detected in the fourth training sample 504D as it is not related to a user-selected system to be running hence the workload 306 may not terminated. The workload 306 may be terminated based on the user-selected set of systems 206 (specified in the configuration file 304) needed to be functional for the execution of the workload 306.

It may be noted that the ‘Hung-workload’ in the training dataset 502 may be a tag for a scenario where the workload 306 may be hung or may have performance degradation, ‘Hung-GPU’ in the training dataset 502 may be a tag for scenario where GPU processor (or GPU accelerator) may be hung, ‘Hung-host’ in the training dataset 502 may be a tag for scenario where the host running workload hangs, and ‘Hung-FS’ in the training dataset 502 may be a tag for scenario where filesystem is hung due to no disk space remaining. It may be noted that the obtained tag values may be used to label the faulty system. It may be further noted that if any one of the event or group systems has issues, then the ML model 216, which may be a classifier may mark an entire job of the execution of the workload 306 as ‘hung’ and the workload management system 202 may further terminate the workload 306 entirely based on the marking.

FIG. 6 is a flowchart that illustrates an exemplary method for an assignment of the output label to a workload termination parameter based on a count of concurrent occurrences of first content in the first event data, in accordance with an embodiment of the disclosure. FIG. 6 is explained in conjunction with elements from FIG. 1, FIG. 2, FIG. 3, FIG. 4, and FIG. 5. With reference to FIG. 6, there is shown a flowchart 600. The operations of the exemplary method may be executed by any computing system, for example, by the computer 102 of FIG. 1 or the workload management system 202 of FIG. 2. The operations of the flowchart 600 may start at 602.

At 602, a count of concurrent occurrences of first content in first event data may be determined. In an embodiment, the workload management system 202 may be configured to determine the count of concurrent occurrences of the first content in the first event data. In an embodiment, the message 414 associated with multiple events may be similar. This may be because the workload may be hung on some system due to any reason. For example, to execute the workload, the first system 206A may have to access a file, but the user may not have privileges to access the file. The first system 206A may be trying to access the file repeatedly after a particular interval (e.g., after every 10 seconds). With each re-try, the same first content may be recorded in the event data 402. The first content may indicate that the requested file may not be accessible.

At 604, it may be determined whether the determined count of concurrent occurrences of the first content is greater than a pre-determined count threshold. The pre-determined count threshold may correspond to a minimum count after which it may be deemed that at least one fault may be present in the first system 206A. In case the determined count may be greater than or equal to the pre-determined count threshold, the control may be transferred to 606. Otherwise, the control may be transferred to 608.

At 606, the output label with the first value may be assigned to the workload termination parameter. In an embodiment, the workload management system 202 may be configured to determine the output label to be assigned to the workload termination parameter. The workload management system 202 may be configured to assign the determined output label of the first value (e.g., ‘1’) to the first workload termination parameter. The first workload termination parameter may be associated with the termination of the workload 306 on the set of systems 206. In case the value of the first termination parameter is ‘1’, the workload management system 202 may be configured to terminate the execution of the workload 306 on the set of systems 206. Details about the workload termination parameter are provided, for example, in FIG. 3.

At 608, the output label with the second value may be assigned to the workload termination parameter. In an embodiment, the workload management system 202 may be configured to determine the output label to be assigned to the workload termination parameter. The workload management system 202 may be configured to assign the determined output label of the second value (e.g., ‘0’) to the first workload termination parameter. The first workload termination parameter may be associated with the termination of the workload 306. In case the value of the first termination parameter is ‘0’, the workload management system 202 may be configured to continue the execution of the workload on the set of systems 206. Control may pass to end.

FIG. 7 is a flowchart that illustrates an exemplary method for an assignment of the output label to a workload termination parameter based on a time period of concurrent occurrences of first content in the first event data, in accordance with an embodiment of the disclosure. FIG. 7 is explained in conjunction with elements from FIG. 1, FIG. 2, FIG. 3, FIG. 4, FIG. 5, and FIG. 6. With reference to FIG. 7, there is shown a flowchart 700. The operations of the exemplary method may be executed by any computing system, for example, by the computer 102 of FIG. 1 or the workload management system 202 of FIG. 2. The operations of the flowchart 700 may start at 702.

At 702, a time period from a first timestamp associated with a first occurrence of concurrent occurrences of the first content present in the first event data until a current timestamp may be calculated. In an embodiment, the workload management system 202 may be configured to calculate the time period from the first timestamp associated with the first occurrence of concurrent occurrences of first content present in the first event data until the current timestamp. The first timestamp may include the time at which the first occurrence of concurrent occurrences of the first content may be logged in the event data. In an embodiment, the first timestamp may be determined from the age 410 field from the event data.

In an embodiment, the message 414 associated with multiple events may be same. This may be because the workload may be hung on some systems. For example, to execute the workload, the first system 206A may have to access a file, but the user may not have privileges to access the file. The first system 206A may be trying to access the file repeatedly after a particular interval (e.g., after every 10 seconds). With each re-try, the same first content may be recorded in the event data (specifically the message 414 field of the corresponding event). For example, the first content may indicate that the requested file may not be accessible.

The workload management system 202 may determine the first timestamp when the first event with the message 414 may be received. Once the first timestamp is determined, the workload management system 202 may be configured to determine the current timestamp. In another embodiment, the workload management system 202 may be configured to determine a second timestamp when the event with the same message as that of the first event may be received. The workload management system 202 may be further configured to calculate the time period between the determined first timestamp and the current timestamp (or the second timestamp).

At 704, it may be determined whether the calculated time period is greater than a pre-determined time period threshold. The pre-determined time period threshold may correspond to a minimum time period after which it may be deemed that a fault may be present in the first system 206A. In case the calculated time period may be greater than or equal to the pre-determined time period threshold, the control may be transferred to 706. Otherwise, the control may be transferred to 708.

At 706, the output label with the first value may be assigned to the workload termination parameter. In an embodiment, the workload management system 202 may be configured to determine the output label to be assigned to the workload termination parameter. The workload management system 202 may be configured to assign the determined output label of the first value (e.g., ‘1’) to the first workload termination parameter. The first workload termination parameter may be associated with the termination of the workload 306. In case the value of the first termination parameter is ‘1’, the workload management system 202 may be configured to terminate the execution of the workload on the set of systems 206. Details about the workload termination parameter are provided, for example, in FIG. 3.

At 708, the output label with the second value may be assigned to the workload termination parameter. In an embodiment, the workload management system 202 may be configured to determine the output label to be assigned to the workload termination parameter. The workload management system 202 may be configured to assign the determined output label of the second value (e.g., ‘0’) to the first workload termination parameter. The first workload termination parameter may be associated with the termination of the workload 306. In case the value of the first termination parameter is ‘0’, the workload management system 202 may be configured to continue the execution of the workload on the set of systems 206. Control may pass to end.

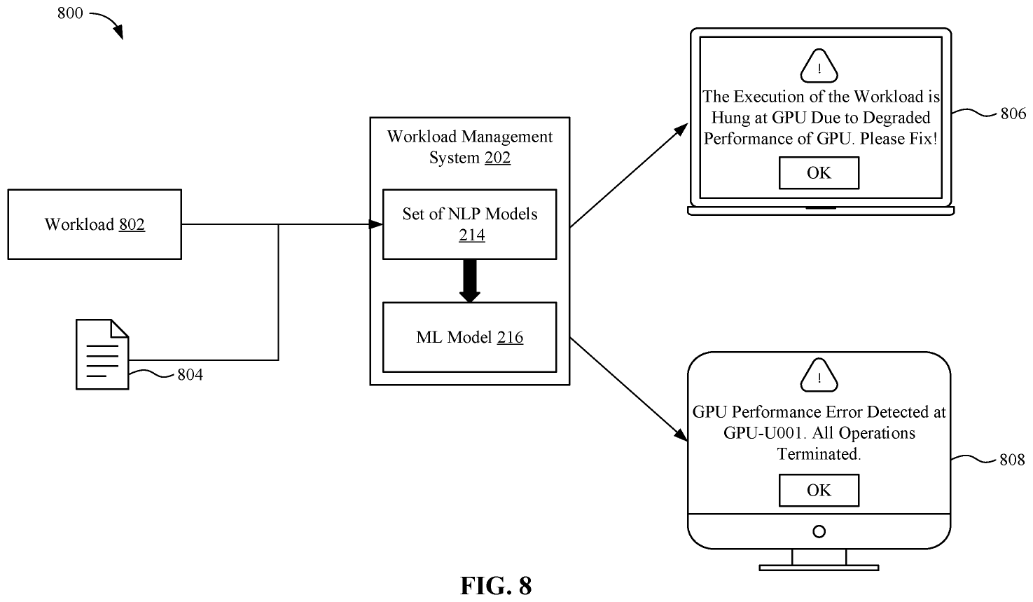

FIG. 8 is an exemplary diagram that illustrates an exemplary use case scenario for improving scheduling of workload by identifying faults in systems, in accordance with an embodiment of the disclosure. FIG. 8 is explained in conjunction with elements from FIG. 1, FIG. 2, FIG. 3, FIG. 4, FIG. 5, FIG. 6, and FIG. 7. With reference to FIG. 8, there is shown an exemplary diagram 800. With reference to FIG. 8, there is further shown a configuration file 802, a workload 804, an end-user device (EUD) 806, and an administrator device 808. There is further shown the workload management system 202 of FIG. 2 in FIG. 8.

As discussed above, the workload management system 202 may be configured to receive the configuration file 802 that may be associated with the set of systems 206. The configuration file 802 may include information associated with the configuration of the set of systems 206 used for an execution of the workload 804. The configuration file may be written in a mark-up language. The mark-up language may correspond to one of a yet another markup language (YAML), a hypertext markup language (HTML), an extensible markup language (XML), a JavaScript object notation (JSON), a standard generalized markup language (SGML), or an extensible hypertext markup language (XHTML). Details about the configuration file are provided, for example, in FIG. 3.

The workload management system 202 may be further configured to retrieve the event data 402 associated with the set of events 404 occurring during the execution of the workload 306 using the set of systems 206. The set of systems 206 may be hosted on the cloud network and may include at least one of a processor system, a graphics processor system, a file system, and a memory system. Details about the set of systems 206 are provided, for example, in FIG. 2 and FIG. 3,

The workload management system 202 may be further configured to determine the first set of parameters from the first event data associated with the first event 404A of the set of events 404. The first set of parameters may be associated with the first system 206A of the set of systems 206 and may include information associated with a current status of the first system 206A. In an embodiment, the first set of parameters may be determined based on an application of a first natural language processing (NLP) model of the set of NLP models 214 on the first event data. In an embodiment, the set of NLP models 214 may be associated with the set of systems 206. Details about the first set of parameters are provided, for example, in FIG. 3 and FIG. 5.

In an embodiment, the workload management system 202 may be configured to determine the presence of the first configuration data associated with the first system 206A within the received configuration file 304. The workload management system 202 may be configured to assign the output label of a first value to the first workload termination parameter based on the determined first set of parameters and the determined presence of first configuration data associated with the first system 206A within the received configuration file 304.

In another embodiment, the workload management system 202 may be configured to determine an absence of the first configuration data associated with the first system 206A within the received configuration file 304. The workload management system 202 may be configured to assign the output label of the second value to the first workload termination parameter based on the determined first set of parameters and the determined absence of first configuration data associated with the first system 206A within the received configuration file 304.

In an alternate embodiment, the workload management system 202 may be configured to assign the output label to the first workload termination parameter based on an application of the ML model 216 on the determined first set of parameters and the received configuration file 304.

In another embodiment, the workload management system 202 may be configured to determine the count of concurrent occurrences of the first content in the first event data. The workload management system 202 may be further configured to compare the determined count of concurrent occurrences of the first content with the pre-determined count threshold and assign the output label to the first workload termination parameter based on the comparison.

In another embodiment, the workload management system 202 may be configured to calculate the time period from the first timestamp associated with the first occurrence of concurrent occurrences of the first content present in the first event data until the current timestamp. The workload management system 202 may be further configured to compare the calculated time period with a pre-determined time period threshold and assign the output label to the first workload termination parameter based on the comparison.

The workload management system 202 may be further configured to store the assigned output label to the first workload termination parameter in memory. In another embodiment, the workload management system 202 may be configured to determine the value of the assigned output label to the first workload termination parameter. The workload management system 202 may be further configured to compare the determined value with a first value. In an embodiment, the first value may be ‘1’. The workload management system 202 may be further configured to initiate the execution of the workload on a second system of the set of systems based on the comparison.

In another embodiment, the workload management system 202 may be configured to terminate the execution of the workload on the first system 206A based on an assignment of the output label to the first workload termination parameter. The output label is of a first value. The workload management system 202 may be further configured to output a failure message indicating the termination of the execution of the workload 306 on the first system 206A due to a presence of at least one fault in the first system 206A.

In another embodiment, the workload management system 202 may be configured to determine one or more reasons associated with the assignment of the output label of a first value to the first workload termination parameter based on an analysis of the first event data. The workload management system 202 may be further configured to output the determined one or more reasons. In an embodiment, the one or more reasons may be determined from the first event data by the application of an NLP model of the set of NLP models 214.

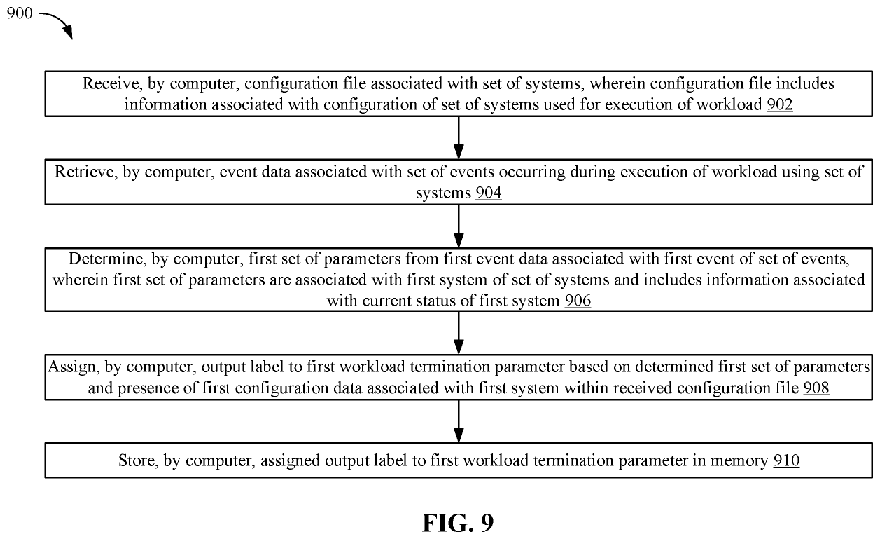

FIG. 9 is a flowchart that illustrates an exemplary method for improving scheduling of workload by identifying faults in systems, in accordance with an embodiment of the disclosure. FIG. 9 is explained in conjunction with elements from FIG. 1, FIG. 2, FIG. 3, FIG. 4, FIG. 5, FIG. 6, FIG. 7, and FIG. 8. With reference to FIG. 9, there is shown a flowchart 900. The operations of the exemplary method may be executed by any computing system, for example, by the computer 102 (or the processing circuitry 114A) of FIG. 1 or the workload management system 202 of FIG. 2. The operations of the flowchart 900 may start at 902.

At 902, the configuration file 304 associated with the set of systems 206 may be received. The configuration file 304 may include information associated with a configuration of the set of systems 206 used for the execution of the workload 306. In at least one embodiment, the workload management system 202 may be configured to receive the configuration file 304 associated with the set of systems 206, wherein the configuration file 304 includes information associated with the configuration of the set of systems 206 used for the execution of the workload 306. Details about the configuration file are provided, for example, in FIG. 3, and FIG. 4.

At 904, the event data 402 associated with the set of events 404 may be retrieved. The retrieved event data 402 may be associated with the set of events 404 occurring during the execution of the workload 306 using the set of systems 206. In at least one embodiment, the workload management system 202 may be configured to retrieve the event data 402 associated with the set of events 404 occurring during the execution of the workload 306 using the set of systems 206. Details about the event data 402 are provided, for example, in FIG. 4.

At 906, the first set of parameters may be determined from the first event data associated with the first event 404A of the set of events 404. The first set of parameters may be associated with the first system 206A of the set of systems 206 and includes information associated with the current status of the first system 206A. In at least one embodiment, the workload management system 202 may be configured to determine the first set of parameters from the first event data associated with the first event 404A of the set of events 404, wherein the first set of parameters is associated with the first system 206A of the set of systems 206 and includes information associated with the current status of the first system 206A. Details about the first set of parameters are provided, for example, in FIG. 5.

At 908, the output label may be assigned to the first workload termination parameter based on the determined first set of parameters and the presence of first configuration data associated with the first system 206A within the received configuration file 304. In at least one embodiment, the workload management system 202 may be configured to assign an output label to a first workload termination parameter based on the determined first set of parameters and a presence of first configuration data associated with the first system 206A within the received configuration file 304. Details about the assignment of the output label are provided, for example, in FIG. 3 and FIG. 5.

At 910, the assigned output label assigned to the first workload termination parameter may be stored in the memory. In at least one embodiment, the workload management system 202 may be configured to store the assigned output label to the first workload termination parameter in the memory. Control may pass to the end.

Various embodiments of the disclosure may provide a non-transitory computer readable medium and/or storage medium having stored thereon, instructions executable by a machine and/or a computer to operate a system (e.g., the workload management system 202) for improving scheduling of workload by identifying faults in systems. The instructions may cause the machine and/or computer to perform operations that include receiving a configuration file associated with a set of systems, wherein the configuration file includes information associated with a configuration of the set of systems used for an execution of a workload. The operations further include retrieving event data associated with a set of events occurring during the execution of the workload using the set of systems. The operations further include determining a first set of parameters from first event data associated with a first event of the set of events. The first set of parameters is associated with a first system of the set of systems and includes information associated with a current status of the first system 206A. The operations further include assigning an output label to a first workload termination parameter based on the determined first set of parameters and a presence of first configuration data associated with the first system within the received configuration file. The operations further include storing the assigned output label to the first workload termination parameter in the memory.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving, by a computer, a configuration file associated with the set of systems, wherein the received configuration file includes information associated with a configuration of the set of systems used for an execution of a workload;
retrieving, by the computer, event data associated with a set of events occurring during the execution of the workload using the set of systems;
determining, by the computer, a first set of parameters from first event data associated with a first event of the set of events, wherein the determined first set of parameters is associated with a first system of the set of systems and comprises information associated with a current status of the first system;
assigning, by the computer, an output label to a first workload termination parameter based on the determined first set of parameters and a presence of first configuration data associated with the first system within the received configuration file; and
storing, by the computer, the assigned output label to the first workload termination parameter in memory.

2. The computer-implemented method of claim 1, wherein the determined first set of parameters are determined based on an application of a first natural language processing (NLP) model of a set of NLP models on the first event data, and wherein the set of NLP models are associated with the set of systems.

3. The computer-implemented method of claim 1, further comprising:
determining, by the computer, the presence of the first configuration data associated with the first system within the received configuration file; and
determining, by the computer, the assigned output label of a first value to the first workload termination parameter further based on the determined presence of the first configuration data associated with the first system within the received configuration file.

4. The computer-implemented method of claim 1, further comprising:
determining, by the computer, an absence of first configuration data associated with the first system within the received configuration file; and
determining, by the computer, the assigned output label of a second value to the first workload termination parameter further based on the determined absence of the first configuration data associated with the first system within the received configuration file.

5. The computer-implemented method of claim 1, further comprising:
determining, by the computer, a count of concurrent occurrences of first content in the first event data;
comparing, by the computer, the determined count of concurrent occurrences of the first content with a pre-determined count threshold; and
determining, by the computer, the assigned output label of the first workload termination parameter based on the comparison.

6. The computer-implemented method of claim 1, further comprising:
calculating, by the computer, a time period from a first timestamp associated with a first occurrence of concurrent occurrences of first content present in the first event data until a current timestamp;
comparing, by the computer, the calculated time period with a pre-determined time period threshold; and
determining, by the computer, the assigned output label of the first workload termination parameter based on the comparison.

7. The computer-implemented method of claim 1, further comprising:
determining, by the computer, a value of the assigned output label to the first workload termination parameter;
comparing, by the computer, the determined value with a first value; and
initiating, by the computer, the execution of the workload on a second system of the set of systems is based on the comparison.

8. The computer-implemented method of claim 1, further comprising:
terminating, by the computer, the execution of the workload on the first system based on the assigned output label to the first workload termination parameter, wherein the output label is of a first value; and
outputting, by the computer, a failure message indicating the termination of the execution of the workload on the first system due to a presence of at least one fault in the first system.

9. The computer-implemented method of claim 1, further comprising:
determining, by the computer, one or more reasons associated with the assigned output label of a first value to the first workload termination parameter based on an analysis of the first event data; and
outputting, by the computer, the determined one or more reasons, wherein the determined one or more reasons are determined from the first event data.

10. The computer-implemented method of claim 9, wherein the determined one or more reasons are determined based on an application of a second NLP model of a set of NLP models on the first event data.

11. The computer-implemented method of claim 1, wherein the set of systems are hosted on a cloud network.

12. The computer-implemented method of claim 1, wherein the set of systems comprises at least one of a processor system, a graphics processor system, a file system, and a memory system.

13. The computer-implemented method of claim 1, further comprising determining, by the computer, the assigned output label of the first workload termination parameter based on an application of a machine learning (ML) model on the determined first set of parameters and the received configuration file.

14. The computer-implemented method of claim 1, wherein the configuration file is written in a mark-up language, and wherein the mark-up language is selected from the group consisting of a yet another markup language (YAML), a hypertext markup language (HTML), an extensible markup language (XML), a JavaScript object notation (JSON), a standard generalized markup language (SGML), and an extensible hypertext markup language (XHTML).

15. A system comprising:
processing circuitry configured to:
receive a configuration file associated with a set of systems, wherein the configuration file includes information associated with a configuration of the set of systems used for an execution of a workload;
retrieve event data associated with a set of events that occur during the execution of the workload by the set of systems;
determine a first set of parameters from first event data associated with a first event of the set of events, wherein the first set of parameters is associated with a first system of the set of systems and comprises information associated with a current status of the first system;
assign an output label to a first workload termination parameter based on the determined first set of parameters and a presence of first configuration data associated with the first system within the received configuration file; and
store the assigned output label to the first workload termination parameter in memory.

16. The system of claim 15, wherein the first set of parameters is determined based on an application of a first natural language processing (NLP) model of a set of NLP models on the first event data, and wherein the set of NLP models are associated with the set of systems.

17. The system of claim 15, wherein the processing circuitry is further configured to:
determine the presence of the first configuration data associated with the first system within the received configuration file; and
determine the assigned output label of a first value to the first workload termination parameter further based on the determined presence of the first configuration data associated with the first system within the received configuration file.

18. The system of claim 15, wherein the processing circuitry is further configured to:
determine an absence of first configuration data associated with the first system within the received configuration file; and
determine the assigned output label of a second value to the first workload termination parameter further based on the determined absence of the first configuration data associated with the first system within the received configuration file.

19. The system of claim 15, wherein the set of systems comprises at least one of a processor system, a graphics processor system, a file system, and a memory system.

20. A computer program product for identifying fault in a set of systems, the computer program product comprising one or more computer readable storage media, and program instructions collectively stored on the one or more computer readable storage media, the program instructions comprising:
program instructions to receive a configuration file associated with the set of systems, wherein the configuration file includes information associated with a configuration of the set of systems used for an execution of a workload;
program instructions to retrieve event data associated with a set of events occurring during the execution of the workload using the set of systems;
program instructions to determine a first set of parameters from first event data associated with a first event of the set of events, wherein the first set of parameters is associated with a first system of the set of systems and comprises information associated with a current status of the first system;
program instructions to assign an output label to a first workload termination parameter based on the determined first set of parameters and a presence of first configuration data associated with the first system within the received configuration file; and
program instructions to store the assigned output label to the first workload termination parameter in memory.
